(19) United States
(12) Patent Application Publication
(10) Pub. No.: US 2026/0005637 A1
(43) Pub. Date: Jan. 1, 2026

(54) MULTI-SPOOL ENGINE ELECTRICAL LOAD BALANCING TO OPTIMIZE FUEL BURN BASED ON AMBIENT AND SYSTEM THERMAL CONDITIONS

(71) Applicant: Hamilton Sundstrand Corporation, Charlotte, NC (US)

(72) Inventors: Tyler W. Hayes, Rockford, IL (US); Aaron Christopher Day, Sevenoaks (GB); Thomas E. Clark, Wells, ME (US)

(21) Appl. No.: 18/760,690

(22) Filed: Jul. 1, 2024

(51) Int. Cl. H02P 29/60; F02C 9/26; F02C 9/28; H02P 9/02

(52) U.S. Cl. CPC H02P 29/60; F02C 9/26; F02C 9/28; H02P 9/02

(57) ABSTRACT

A first electrical machine is configured to act as an electrical motor in a first mode and an electrical generator in a second mode. Each first electrical machine is associated with a high-pressure spool of a turbine engine. A first controller is configured to control a load level of the first electrical machine responsive to a first load level control signal. A second electrical machine is configured to act as an electrical motor in the first mode and as an electrical generator in the second mode. The second electrical machine is associated with a low-pressure spool of the turbine engine. A second controller is configured to control a load level of the second electrical machine responsive to a second load level control signal. A third controller is configured to generate the first load level control signal and the second load level control signal responsive to temperatures of the first electrical machine, the first controller, the second electrical machine, and the second controller.

### TECHNICAL FIELD

This disclosure relates generally to load balancing of gas turbine engines. More specifically, this disclosure relates to multi-spool engine electrical load balancing to optimize fuel burn based on ambient and system thermal conditions.

### BACKGROUND

Electric machines are used as a motor or generator on two different spools of a gas turbine engine in order to optimize fuel burn. During ground performance, there is very little airflow through an engine thermal management system (TMS), which greatly limits the ability to operate an electrical system to a full expected performance level. An electrical load can be dynamically balanced between the different spools during these conditions in order to optimize fuel burn and improve operation of the TMS. Electrified propulsion high-power machines and electronics often require novel TMS solutions, since electric machines may be larger than legacy aircraft and power electronics may be installed on engines. For example, legacy aircraft do not have generators on their low-pressure spools, and generation occurs only from high-power spools with limited ability to optimize this extraction.

### SUMMARY

This disclosure relates to multi-spool engine electrical load balancing to optimize fuel burn based on ambient and system thermal conditions.

In some examples, a system for electrical load balancing within a turbine engine includes a first electrical machine configured to act as an electrical motor in a first mode and as an electrical generator in a second mode. Each first electrical machine is associated with a high-pressure spool of the turbine engine. The system also includes a first controller configured to control a load level of the first electrical machine responsive to a first load level control signal. The system further includes a second electrical machine configured to act as an electrical motor in the first mode and as an electrical generator in the second mode. The second electrical machine is associated with a low-pressure spool of the turbine engine. The system also includes a second controller configured to control a load level of the second electrical machine responsive to a second load level control signal. In addition, the system includes a third controller configured to generate the first load level control signal and the second load level control signal responsive to temperatures of the first electrical machine, the first controller, the second electrical machine, and the second controller.

Any single one or any combination of the following features may be used with the examples above. The third controller may be configured to generate the first load level control signal and the second load level control signal to alter the load levels of the first electrical machine and the second electrical machine to decrease an overall system temperature. The first load level control signal may decrease the load level of the first electrical machine to decrease the temperature of the first electrical machine, and the second load level control signal may increase the load level of the second electrical machine. The third controller may include a thermal management system configured to monitor the temperatures of the first electrical machine, the first controller, the second electrical machine, and the second controller and generate temperature control signals responsive thereto. The third controller may also include a system supervisory controller configured to generate the first load level control signal and the second load level control signal responsive to the temperature control signals from the thermal management system. The third controller may be configured to generate the first load level control signal and the second load level control signal to decrease an overall system temperature and reduce fuel consumption of the turbine engine. The third controller may be configured to (i) decrease a current provided from the first electrical machine to decrease the load level of the first electrical machine and increase the current provided from the second electrical machine to increase the load level of the second electrical machine responsive to the temperature of the first electrical machine in the first mode and (ii) increase the current provided from the first electrical machine to increase the load level of the first electrical machine and decrease the current provided from the second electrical machine to decrease the load level of the second electrical machine responsive to the temperature of the first electrical machine in the second mode. The first controller and the second controller may each include a motor controller/rectifier configured to operate as a motor controller in the first mode and as a rectifier in the second mode. The system may include a liquid cooling loop configured to cool the first electrical machine, the first controller, the second electrical machine, and the second controller and provide the temperature of the first electrical machine with respect thereto to the third controller.

In other examples, a system for electrical load balancing within a turbine engine includes a first electrical machine configured to act as an electrical motor in a first mode and as an electrical generator in a second mode. Each first electrical machine is associated with a high-pressure spool of the turbine engine. The system also includes a first controller configured to control a load level of the first electrical machine responsive to a first load level control signal. The system further includes a second electrical machine configured to act as an electrical motor in the first mode and as an electrical generator in the second mode. The second electrical machine is associated with a low-pressure spool of the turbine engine. The system also includes a second controller configured to control a load level of the second electrical machine responsive to a second load level control signal. The system further includes a thermal management system configured to monitor the temperatures of the first electrical machine, the first controller, the second electrical machine, and the second controller and generate temperature control signals responsive thereto. In addition, the system includes a system supervisory controller configured to generate the first load level control signal and the second load level control signal responsive to the temperature control signals from the thermal management system. The system supervisory controller is configured to generate the first load level control signal and the second load level control signal to decrease an overall system temperature and reduce fuel consumption of the turbine engine.

Any single one or any combination of the following features may be used with the examples above. The first load level control signal may decrease the load level of the first electrical machine to decrease the temperature of the first electrical machine, and the second load level control signal may increase the load level of the second electrical machine. The system supervisory controller may be further configured to (i) decrease a current provided from the first electrical machine to decrease the load level of the first electrical machine and increase the current provided from the second electrical machine to increase the load level of the second electrical machine responsive to the temperature of the first electrical machine in the first mode and (ii) increase the current provided from the first electrical machine to increase the load level of the first electrical machine and decrease the current provided from the second electrical machine to decrease the load level of the second electrical machine responsive to the temperature of the first electrical machine in the second mode. The first controller and the second controller may each include a motor controller/rectifier configured to operate as a motor controller in the first mode and as a rectifier in the second mode. The system may include a liquid cooling loop configured to cool the first electrical machine, the first controller, the second electrical machine, and the second controller and provide the temperature of the first electrical machine with respect thereto to the system supervisory controller.

In still other examples, a method for electrical load balancing within a turbine engine includes associating a first electrical machine that is configured to act as an electrical motor in a first mode and as an electrical generator in a second mode with a high-pressure spool of the turbine engine. The method also includes controlling a load level of the first electrical machine responsive to a first load level control signal using a first controller. The method further includes associating a second electrical machine that is configured to act as an electrical motor in the first mode and as an electrical generator in the second mode with a low-pressure spool of the turbine engine. The method also includes controlling a load level of the second electrical machine responsive to a second load level control signal using a second controller. In addition, the method includes generating the first load level control signal and the second load level control signal responsive to temperatures of the first electrical machine, the first controller, the second electrical machine, and the second controller using a third controller.

Any single one or any combination of the following features may be used with the examples above. The first load level control signal and the second load level control signal may alter the load levels of the first electrical machine and the second electrical machine to decrease an overall system temperature. The method may include decreasing the load level of the first electrical machine to decrease the temperature of the first electrical machine using the first load level control signal and increasing the load level of the second electrical machine using the second load level control signal. The method may include monitoring the temperatures of the first electrical machine, the first controller, the second electrical machine and the second controller and generating temperature control signals responsive thereto using a thermal management system. The method may include generating the first load level control signal and the second load level control signal responsive to the temperature control signals from the thermal management system using a system supervisory controller. The first load level control signal and the second load level control signal may decrease an overall system temperature and reduce fuel consumption of the turbine engine. The method may include, in the first mode, decreasing a current provided from the first electrical machine to decrease the load level of the first electrical machine and increasing the current provided from the second electrical machine to increase the load level of the second electrical machine responsive to the temperature of the first electrical machine. The method may include, in the second mode, increasing the current provided from the first electrical machine to increase the load level of the first electrical machine and decreasing the current provided from the second electrical machine to decrease the load level of the second electrical machine responsive to the temperature of the first electrical machine. The method may include configuring each of the first controller and the second controller as a motor controller/rectifier to operate as a motor controller in the first mode and as a rectifier in the second mode.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a block diagram of a gas turbine engine having an electrical generation system associated with a high-pressure spool and a low-pressure spool;

FIG. 2 illustrates a block diagram of a system for providing load-balancing based on ambient and system thermal conditions;

FIG. 3 illustrates a power versus time plot of operation of electrical loads for a high-pressure spool and a low-pressure spool; and

FIG. 4 illustrates a channel temperature versus time plot of operation for a high-pressure spool and a low-pressure spool.

### DETAILED DESCRIPTION

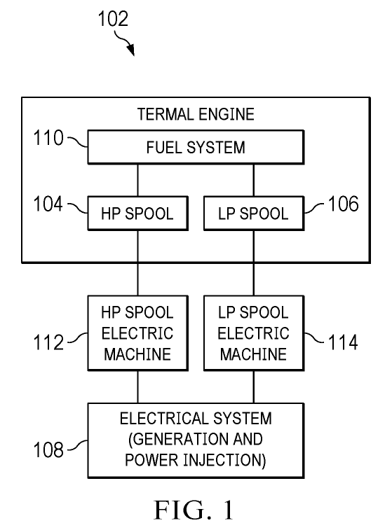

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

FIG. 1 illustrates a general block diagram of a gas turbine engine 102 that includes a low-pressure spool 106 and a high-pressure spool 104. Each of the low-pressure spool 106 and the high-pressure spool 104 is driven by a fuel-based system 110 and also connected to an electrical system 108, which is capable of either extracting power or injecting power from/to the high-pressure spool 104 or low-pressure spool 106 via high-pressure spool electric machine 112 or low-pressure spool electric machine 114. The control of the electrical generation system 108 may be altered based upon various thermal effects detected in the electrical generation system in order to balance the loads supported by the electrical generating system 108 and provide optimize fuel consumption from the fuel-based system 110. The number of HP motor controllers/rectifiers and electric machines may change for a given architecture. For example, if there were one high pressure spool electric machines 112 instead of two or if there were two low pressure spool electric machines 114 instead of one, or if there was a transmission that allows switching of high pressure and low pressure machines between spools 104,106. The engine high pressure spool 104 and low pressure spool 106 are driven by a thermal engine 102 Connected to these engine spools (usually via gearbox) is an electric generator 112, 114. Modulating the amount of load on each generator 112, 114 in turn increases or decreases the amount of torque applied to the high or low pressure spools 104, 106, which affects the amount of fuel required to operate the engine 102 in that more or less thrust is needed to overcome the amount of power generation being utilized. Similarly, when operating these electric machines 112, 114 as motors torque is injected onto the low or high pressure spool 104, 106, which changes the amount of fuel required to the engine 102.

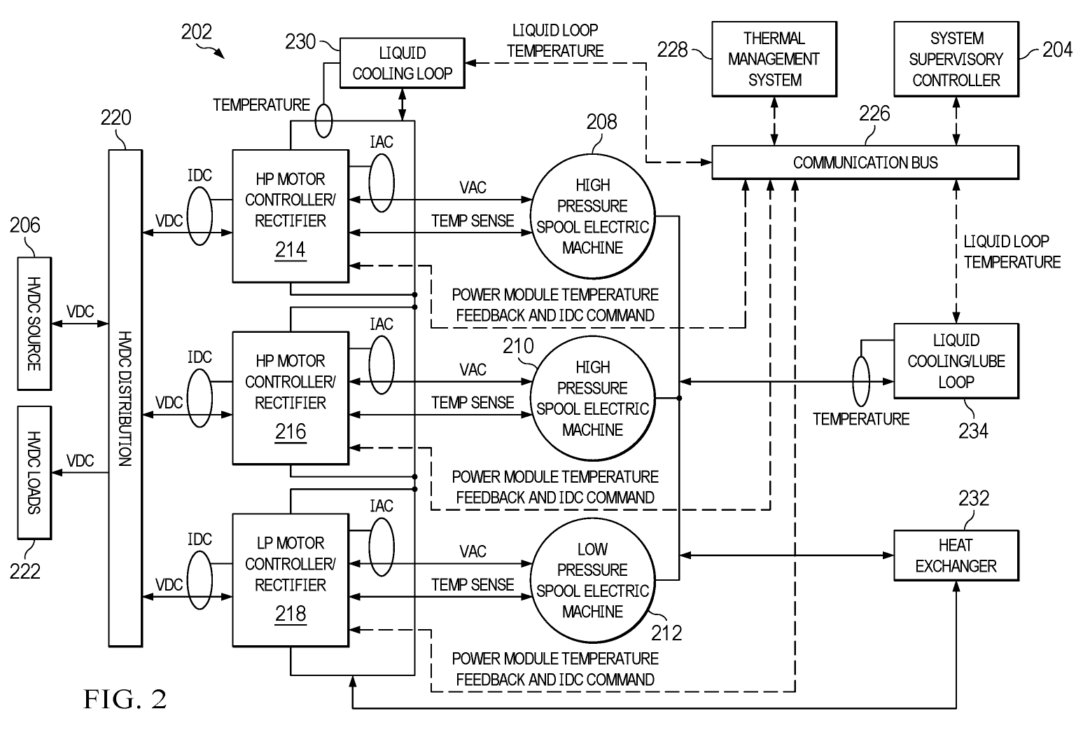

FIG. 2 illustrates a system for dynamically load-balancing between the two different spools of a gas turbine engine in order to optimize fuel burn and temperature based on ambient and system temperatures. To ensure the most optimal split of power extraction between the high-pressure spool 104 and the low-pressure spool 106 and improve fuel burn while optimizing thermal management system (TMS) utilization, extraction limits can be actively determined on each spool to reduce thermal impacts while continuing to optimize fuel burn for the aircraft. This can occur via current limit to either spool converter or shifting current (load) to the other spool’s converter. The amount of current offloaded can be dynamically determined via the ambient temperature, converter temperature, or TMS temperature based on a preprogrammed current limit curve in the converter software. An engine controller can also provide input into this feedback to ensure optimal engine performance. This technology can be useful in optimizing fuel burn through not only the optimization of engine spooling load but also by reducing weight of the engine TMS.

FIG. 2 depicts a block diagram of a system 202 utilizing a supervisory controller 204 for active power regulation of parallel high voltage DC sources 206. The system 202 includes two electric machines 208, 210 that are arranged in parallel and connected to the high-pressure spool 104 of the of the gas turbine engine 102. Additionally, an electric machine 212 is connected to the low-pressure spool 106 of the gas turbine engine 102. While the illustrated example shows only three electric machines 208, 210 and 212, any number of parallel power sources can be utilized in one or more embodiments. The system 202 also includes a pair of high-pressure motor controllers/rectifiers 214, 216 connected to electric machines 208 and 210, respectively. The motor controller portion controls operation of the electrical machine 208, 210 when operating as a motor to provide electrical power to drive the high-pressure spool 104. When operating in the rectifier mode, the motor controllers/rectifiers 214, 216 act as a rectifier, which can be any type of rectifier circuit including but not limited to active and passive rectifiers. The rectifier mode of the motor controllers/rectifiers 214, 216 converts AC power from the electric machines 208, 210 to DC power. In one or more embodiments, the DC power voltage is a high voltage DC (HVDC).

The system 202 also includes a single low-pressure motor controller/rectifier 218 connected to electric machine 212. The motor controller portion controls operation of the electrical machine 212 when operating as a motor to provide electrical power to drive the low-pressure spool 106. When operating in the rectifier mode, the motor controller/rectifier 218 acts as a rectifier, which can be any type of rectifier circuit including but not limited to active and passive rectifiers. The rectifier mode of the motor controller/rectifier 218 converts AC power from the electric machines 212 to DC power. In one or more embodiments, the DC power voltage is a high voltage DC (HVDC). The DC signals from the motor controllers/rectifiers 214, 216, 218 are provide to a HVDC distribution network 220. The HVDC distribution network 220 provides HV power to and from the HV source 206 and to HVDC loads 222. The motor controllers/rectifiers 214, 216, 218 are configured to receive current and voltage readings and/or signals from the respective electric machines 208, 210, 212.

The system 202 also includes a supervisory controller 204. The supervisory controller 204 is configured to provide load power percentage commands to the motor controllers/rectifiers 214, 216, 218, which designate the percentage of the overall load power required from or to each electric machine 208, 210 and 212. The motor controllers/rectifiers 214, 216, 218 regulate the DC power to achieve the desired load share for each source. In one or more embodiments, the supervisory controller 204 can determine the appropriate load sharing command to provide based on aircraft operating conditions and one or more performance goals. For example, if the electric machines 208, 210, 212 are connected to the low-pressure and high-pressure spools 104, 106 of the gas turbine engine 102, respectively, the load sharing could be adjusted to optimize fuel burn.

The supervisory controller 204 communicates with the motor controllers/ rectifiers 214, 216, 218 over a communications bus 226. The communications bus 226 enables the supervisory controller 204 to transmit commands to each of the motor controllers/rectifiers 214, 216, 218. A thermal management system 228 enables monitoring of the ambient temperatures and system operating temperatures with respect to the motor controllers/rectifiers 214, 216, 218. These temperatures are provided to the motor controllers/rectifiers 214, 216, 218 from temperature sense signals that are provided from the electric machines 208, 210 and 212. These monitored temperatures with respect to the motor controllers/rectifiers 214, 216, 218 and the electric machines 208, 210, 212 are used to balance the temperatures being provided from each electric machine/motor controller/rectifier pair. For example, if the motor controller/rectifier 214 and electric machines 208 are operating at a high load and temperature, additional load could be switched to the motor controller/rectifier 216 and electric machine 210 as well as to the motor controller/rectifier 218 and electric machine 212 associated with the low-pressure spool in order to lower the thermal temperatures associated with the motor controller/rectifier 214 and electric machine 208 and provide a greater thermal weight to the other motor controller/rectifier and electric machine pairs.

Cooling of the motor controllers/rectifiers 214, 216, 218 and their respective electric machines 208, 210, 212 are provided via a liquid cooling loop 230 that circulates cooling liquids around the motor controllers/rectifiers 214, 216, 218 and the electric machines 208, 210, 212. Liquid cooling loop 237 cools the devices in conjunction with a heat exchanger 232. The cooling loop temperatures are monitored via the liquid cooling loop 230 and provides this information to the thermal management system 228 via the communication bus 226.

The supervisory controller 204 provides the power operating limit and motoring performance inputs for each electric machines 208, 210, 212 to the motor controllers/rectifiers 214, 216, 218. The motor controllers/rectifiers 214, 216, 218 provide the temperatures to the thermal management system 228 via the communications bus 226. The thermal management system 228 may provide temperature control load-balancing information to the system supervisory controller 204 via the communication bus 226. The motor controllers/rectifiers 214, 216, 218 use the current signals and/or values and the temperature values to determine the appropriate command to regulate the power of the respective electric machines 208, 210, 212 to share the total load on the system at the percentage provided by the supervisory controller 204.

In one or more embodiments, the motor controllers/rectifiers 214, 216, 218 are configured to reduce or “drop” the voltage output of the associated electric machine 208, 210, 212 if that particular machine has created too high of a temperature load on the system responsive to sensing a temperature level measured from the thermal management system 228. The motor controllers/rectifiers 214, 216, 218 adjust the drop of the load levels of their respective electric machine 208, 210, 212 while increasing the load levels of electric machines having a lower thermal value using the respective percentage command received from the supervisory controller 204.

In a system where the temperature of the cooling fluid within the liquid cooling loop 230 is increasing, performance of the motor controllers/rectifiers 214, 216, 218 and electric machines 208, 210, 212 will decrease due to suboptimal cooling. Internal power electronics within the motor controllers/rectifiers 214, 216, 218 will have their temperatures increased because of the reduced cooling benefit from already hot fluid of the liquid cooling loop 237. The thermal management system 228 and heat exchanger 232 can work together by altering the load to the electric machines 208, 210, 212 using the high-pressure motor controllers/rectifiers 214, 216, 28 to prevent exceeding the thermal margins of the motor controllers/rectifiers.

In another example, as temperatures increase throughout the system 202, a power/current limit is set for each motor controller/rectifier 214, 216, 218 based on a curve developed to optimize engine fuel burn and performance. When the temperature limit is exceeded, the system supervisory controller 204 or the motor controllers/rectifiers 214, 216, 218 begin power/current limiting to reduce the heat inserted into the system 202. The power removed from the motor controllers/rectifiers 214, 216, 218 or electric machines 208, 210, 212 reduces the heat caused by loading and shifts this load/heat to other motor controllers/rectifiers that were previously un-utilized or under-utilized during the electric machine function. Power can be more properly balanced across multiple sources, enabling the motor controllers/ rectifiers 214, 216, 218 to operate more efficiently and with better performance. This would reduce overall heat inserted into the system 202 and reduce heat rejection requirements. By doing this, the size of the thermal management system 228 and heat exchangers 232 can be reduced since the temperature of a single motor controller/rectifier 214, 216, 218 is no longer the sizing function. Decreasing the load on the main controller/electric machine pair required for an engine function once a thermal limit is reached and balancing the load with other devices spread the overall heat to be rejected, reducing temperatures and increasing system performance while still reducing the size of the thermal management system 228.

In some embodiments, engine performance may desire a single electric machine 208, 210, 212 and motor controller/rectifier 214, 260 218 for performance of a function to focus electrical benefit to a specific spool. Balancing the loads overall can have a negative impact on engine performance, but the reduced weight of the thermal management system 228 and reduced air drag impact of a smaller heat exchanger 232 are overall improvements to the engine that offset the impact of not using the desired controller motor. This ultimately results in better overall improved engine operation.

Referring now to FIG. 3, there is illustrated a power versus time chart for the electric machines 208, 210 connected to the high-pressure spool 104 and the electric machine 212 connected to the low-pressure spool 106. Line 302 represents the combined electrical load for both the electric machines 208, 210 associated with the high-pressure spool 104 and the electric machine 212 associated with the low-pressure spool 106. Line 304 represents the electrical load associated with both of the electric machines 208 and 210 associated with the high-pressure spool 104. Line 306 represents the electrical load associated with the electric machine 212 associated with the low-pressure spool 106. The loads are adjusted over time based upon the thermal signature of the electric machines 208 and 210 being too high.

Since these temperatures were too high, the load is decreased at a particular rate beginning at time t₁ for the electric machines 208 and 210 associated with the high-pressure spool 104 to decrease power. Concurrently, the electric load and power associated with the low-pressure spool 106 begins to increase at time t₁ to take over the load that is being dropped from the high-pressure spools 104. A higher rate of decrease of the load and power associated with the high-pressure spools 104 is provided beginning at time t₂. The load and power provided by the low-pressure spool 106 concurrently increases at time t₂. The decrease in the high-pressure spool 104 load and the corresponding increase in the low-pressure spool 106 load stabilize at time t₃. It will be noted that while the electrical load and power are decreasing for the high-pressure spool 104 as indicated by line 304 and increasing with respect to the low-pressure spool 106 as indicated by line 306, the combined electrical load/power as show by line 302 remains constant.

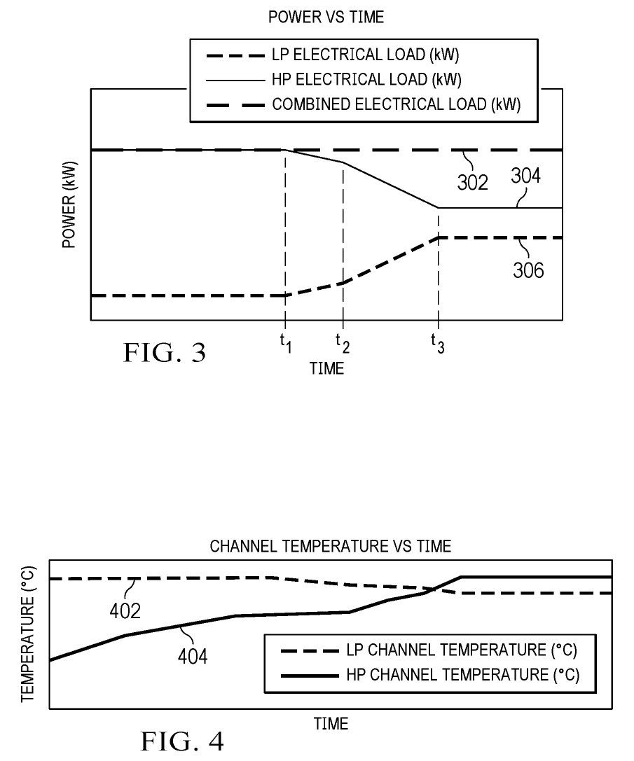

Referring now to FIG. 4, there is illustrated the corresponding channel temperatures for the high-pressure spool and low-pressure spool circuitries. Line 402 represents the high-pressure channel temperature associated with the electric machines 208, 210 and corresponding motor controllers/rectifiers 214, 216. As the load is decreased on the electric machines 208 and 210, the temperature for the high-pressure channel begins to decrease. Concurrently, the low-pressure channel temperature represented by line 404 begins to increase as more load is provided to the electric machine 212 and motor controller/rectifier 218 associated with the low-pressure spool. In this fashion, the thermal load associated with the electrical loads provided by the high-pressure spool 104 and low-pressure spool 106 may be balanced to keep the temperatures relatively balanced over the system.

The performance illustrated in FIGS. 3-4 are merely examples of performance expectation and do not comprise exact results.

Utilizing the above described system, the system can balance electrical loads in order to optimize fuel use within an engine based on ambient and system thermal conditions.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system for electrical load balancing a turbine engine comprising:
a first electrical machine configured to act as an electrical motor in a first mode and as an electrical generator in a second mode, each of the first electrical machine associated with a high-pressure spool of the turbine engine;
a first controller configured to control a load level of the first electrical machine responsive to first load level control signal;
a second electrical machine configured to act as an electrical motor in the first mode and as an electrical generator in the second mode, the second electrical machine associated with a low-pressure spool of the turbine engine;
a second controller configured to control a load level of the second electrical machine responsive to a second load level control signal; and
a third controller configured to generate the first load level control signal and the second load level control signal responsive to temperatures of the first electrical machine, the first controller, the second electrical machine, and the second controller.

2. The system of claim 1, wherein the third controller is configured to generate the first load level control signal and the second load level control signal to alter the load level of the first electrical machine and the second electrical machine to decrease an overall system temperature.

3. The system of claim 1, wherein:
the first load level control signal is configured to decrease the load level of the first electrical machine to decrease the temperature of the first electrical machine; and
the second load level control signal is configured to increase the load level of the second electrical machine.

4. The system of claim 1, wherein the third controller comprises:
a thermal management system configured to monitor the temperatures of the first electrical machine, the first controller, the second electrical machine, and the second controller and generate temperature control signals responsive thereto; and
a system supervisory controller configured to generate the first load level control signal and the second load level control signal responsive to the temperature control signals from the thermal management system.

5. The system of claim 1, wherein the third controller is configured to generate the first load level control signal and the second load level control signal to decrease an overall system temperature and reduce fuel consumption of the turbine engine.

6. The system of claim 1, wherein the third controller is configured to:
decrease a current provided from the first electrical machine to decrease the load level of the first electrical machine and increase a current provided from the second electrical machine to increase the load level of the second electrical machine responsive to the temperature of the first electrical machine in the first mode; and
increase the current provided from the first electrical machine to increase the load level of the first electrical machine and decrease the current provided from the second electrical machine to decrease the load level of the second electrical machine responsive to the temperature of the first electrical machine in the second mode.

7. The system of claim 1, wherein the first controller and the second controller each comprises a motor controller/rectifier configured to operate as a motor controller in the first mode and as a rectifier in the second mode.

8. They system of claim 1, further comprising:
a liquid cooling loop configured to cool the first electrical machine, the first controller, the second electrical machine, and the second controller and provide the temperature of the first electrical machine with respect thereto to the third controller.

9. A system for electrical load balancing within a turbine engine comprising:
a first electrical machine configured to act as an electrical motor in a first mode and as an electrical generator in a second mode, each of the first electrical machine associated with a high-pressure spool of the turbine engine;
a first controller configured to control a load level of the first electrical machine responsive to first load level control signal;
a second electrical machine configured to act as an electrical motor in the first mode and as an electrical generator in the second mode, the second electrical machine associated with a low-pressure spool of the turbine engine;
a second controller configured to control a load level of the second electrical machine responsive to a second load level control signal;
a thermal management system configured to monitor temperatures of the first electrical machine, the first controller, the second electrical machine, and the second controller and generate temperature control signals responsive thereto; and
a system supervisory controller configured to generate the first load level control signal and the second load level control signal responsive to the temperature control signals from the thermal management system, wherein the system supervisory controller is configured to generate the first load level control signal and the second load level control signal to decrease an overall system temperature and reduce fuel consumption of the turbine engine.

10. The system of claim 9, wherein:
the first load level control signal decreases the load level of the first electrical machine to decrease the temperature of the first electrical machine; and
the second load level control signal increases the load level of the second electrical machine.

11. The system of claim 9, wherein the system supervisory controller is configured to:
decrease a current provided from the first electrical machine to decrease the load level of the first electrical machine and increase the current provided from the second electrical machine to increase the load level of the second electrical machine responsive to the temperature of the first electrical machine in the first mode; and
increase the current provided from the first electrical machine to increase the load level of the first electrical machine and decrease the current provided from the second electrical machine to decrease the load level of the second electrical machine responsive to the temperature of the first electrical machine in the second mode.

12. The system of claim 9, wherein the first controller and the second controller each comprises a motor controller/rectifier configured to operate as a motor controller in the first mode and as a rectifier in the second mode.

13. The system of claim 9, further comprising:
a liquid cooling loop configured to cool the first electrical machine, the first controller, the second electrical machine, and the second controller and provide the temperature of the first electrical machine with respect thereto to the system supervisory controller.

14. A method for electrical load balancing within a turbine engine comprising:
associating a first electrical machine that is configured to act as an electrical motor in a first mode and as an electrical generator in a second mode with a high-pressure spool of the turbine engine;
controlling a load level of the first electrical machine responsive to a first load level control signal using a first controller;
associating a second electrical machine that is configured to act as an electrical motor in the first mode and as an electrical generator in the second mode with a low-pressure spool of the turbine engine;
controlling a load level of the second electrical machine responsive to a second load level control signal using a second controller; and
generating the first load level control signal and the second load level control signal responsive to temperatures of the first electrical machine, the first controller, the second electrical machine, and the second controller using a third controller.

15. The method of claim 14, wherein the first load level control signal and the second load level control signal alter the load level of the first electrical machine and the second electrical machine to decrease an overall system temperature.

16. The method of claim 14, further comprising:
decreasing the load level of the first electrical machine to decrease the temperature of the first electrical machine using the first load level control signal; and
increasing the load level of the second electrical machine using the second load level control signal.

17. The method of claim 14, further comprising:
monitoring the temperatures of the first electrical machine, the first controller, the second electrical machine and the second controller and generating temperature control signals responsive thereto using a thermal management system; and
generating the first load level control signal and the second load level control signal responsive to the temperature control signals from the thermal management system using a system supervisory controller.

18. The method of claim 14, wherein the first load level control signal and the second load level control signal decrease an overall system temperature and reduce fuel consumption of the turbine engine.

19. The method of claim 14, further comprising:
in the first mode, decreasing a current provided from the first electrical machine to decrease the load level of the first electrical machine and increasing the current provided from the second electrical machine to increase the load level of the second electrical machine responsive to the temperature of the first electrical machine; and
in the second mode, increasing the current provided from the first electrical machine to increase the load level of the first electrical machine and decreasing the current provided from the second electrical machine to decrease the load level of the second electrical machine responsive to the temperature of the first electrical machine.

20. The method of claim 14, further comprising configuring each of the first controller and the second controller as a motor controller/rectifier to operate as a motor controller in the first mode and as a rectifier in the second mode.
